(19) United States
(12) Patent Application Publication
(10) Pub. No.: US 2014/0190938 A1
(43) Pub. Date: Jul. 10, 2014

(54) PUFFER TYPE GAS CIRCUIT BREAKER

(71) Applicant: Masanori Tsukushi, Tokyo (JP)

(72) Inventor: Masanori Tsukushi, Tokyo (JP)

(21) Appl. No.: 14/240,757

(22) PCT Filed: Aug. 2, 2012
(86) PCT No.: PCT/JP2012/069687

§ 371 Date: Feb. 25, 2014

(30) Foreign Application Priority Data
Sep. 6, 2011 (JP) 2011-193444

(51) Int. Cl. H01H 33/88; H01H 33/82; H01H 33/70

(52) U.S. Cl. CPC H01H 33/88; H01H 33/7023; H01H 33/82
USPC 218/63

(57) ABSTRACT

This puffer type gas circuit breaker has: a stationary-side main contact 2 and a movable-side main contact 3, which are provided on the same axis inside a vessel 1 filled with an insulating gas; a stationary-side arcing contact 4; a movable-side arcing contact 5; a puffer cylinder 6; a puffer shaft 7 having a puffer chamber-side exhaust hole 7a and an operation rod-side exhaust hole 7b; a pressure-activated valve 15 for closing the operation rod-side exhaust hole 7b; a puffer piston 9; a flow control section 11 having an opening part 11a; and an insulating nozzle 12. When the interruption operation is completed, a predetermined space is formed inside a puffer chamber 10, the puffer chamber-side exhaust hole 7a and the opening part 11a are connected together, and the operation rod-side exhaust hole 7b is closed by the pressure-activated valve 15.

### TECHNICAL FIELD

The present invention relates to a puffer type gas circuit breaker particularly to a puffer type gas circuit breaker for protecting an electrical generator circuit to interrupt a large current associated with an accident and zero-miss current (also referred to as zero-missing current) while ensuring a longer interruptible time approximately four cycles.

### BACKGROUND ART

A circuit breaker commonly used in an electric power transmission-transformation system has been understood having necessary and sufficient interruption performance if the arcing time is 1 to 1.5 cycles. On the other hand, in a high-speed automatic grounding device (hereinafter referred to as HSGS) for a 1100 kV ultra high voltage (UHV) system, zero-miss current (or zero-missing current), an alternating current wave form of which does not pass through the zero point, appears due to superposition of a direct current component on the induced static current to be interrupted if an accident occurs in the other line on opening of operation of the device (i.e., at the time of interruption of the electrostatically induced current come from the transmission line). The zero-missing current is a current in which the zero current point does not appear for a longer time about four cycles; a commonly used circuit breaker therefore cannot interrupt such current.

Patent Literature 1 has disclosed the configuration of an HSGS that allows to ensure a long interruptible time equivalent to approximately four cycles. The configuration and constituents therein are as follows: A first puffer chamber is formed by a puffer cylinder having flange portion of an approximate-cylindrical shape and a shaft portion, and a fixed piston; and the fixed piston is formed into a cylindrical shape that is sealed against the outside space and is arranged so that it will be provided in the flange portion of the puffer cylinder when the interruption section comes to the circuit interrupted position; and the inside space thereof is arranged so as to work as a second puffer chamber that communicates with the first puffer chamber. Thereby, the accommodation part of the flange portion of the puffer cylinder is made to have the second puffer chamber, which makes it possible to continue blowing the gas accumulated in the second puffer chamber between electrodes permitting lengthening the effective arcing time.

FIG. 11 shows the characteristic diagram showing the puffer pressure changes in the HSGS according to the conventional art in Patent Literature 1. S in the figure represents the displacement of the movable electrode from the circuit closed position “C” of the interruption section to the circuit interrupted position “O” of the same. The pressure increase P at that time is indicated in waveforms with the dotted line for the case where the configuration includes the first puffer chamber only, and with the solid line for the case where the configuration includes the second puffer chamber in addition to the first one. Thus, the expanding of the puffer chamber capacity by providing a second puffer chamber newly on the part that was conventionally only an accommodation part of the flange portion of the puffer cylinder enables interruption of the zero-missing current within a size comparable to conventional circuit breakers and with less increase in weight.

Characteristics of the interruption performance of this conventional art include, as shown in FIG. 11, a gradual decrease of the puffer pressure in a longer arcing time. This means that the art will be applied without any problems to an HSGS that does not intend a use for interruption of a large current. However, this art includes such a problem as is not suitable for a reliable interruption of a large current that flows at the time of accident ensuring a longer interruptible time of approximately four cycles as in a circuit breaker for protecting an electrical generator circuit.

### LITERATURES OF CONVENTIONAL ART

### Patent Literatures

{Patent Literature 1} Japanese Patent Application Laid-open No. Hei 6-310000

### SUMMARY OF INVENTION

### Problem the Invention Intends to Solve

In view of problems stated above, the present invention particularly intends to provide a puffer type gas circuit breaker for protecting an electrical generator circuit, wherein such circuit breaker is intended to be capable of interrupting a zero-missing current, which is difficult to interrupt with an ordinary circuit breaker, by ensuring a longer interruptible time of approximately four cycles and also capable of interrupting a large current associated with an accident.

### Means for Solving the Problem

A puffer type gas circuit breaker by the present invention has: a vessel that is to be filled with insulating gas; a stationary-side main contact and a movable-side main contact that are provided in the vessel and arranged on the same axis so that they position to face each other in opposite directions; a stationary-side arcing contact and a movable-side arcing contact that are concentrically provided inside the stationary-side main contact and the movable-side main contact respectively; a puffer cylinder that has, on its top end, the movable-side arcing contact; a puffer shaft having a puffer chamber-side exhaust hole and an operation rod-side exhaust hole, wherein the puffer shaft is concentrically provided inside the puffer cylinder; a closing member that closes the operation rod-side exhaust hole; a puffer piston that slides on the inner surface of a space formed by the puffer cylinder and the puffer shaft; a flow control section having an opening part that is communicable with the puffer chamber-side exhaust hole, wherein the flow control section is provided on the puffer piston and arranged in a puffer chamber formed by the puffer cylinder and the puffer shaft and the puffer piston; and an insulating nozzle provided concentrically with the movable-side arcing contact, wherein the insulating nozzle blows an insulating gas compressed within the puffer chamber to the arc produced between the stationary-side arcing contact and the movable-side arcing contact; wherein, on completion of the interruption operation (also referred to as the interruption movement), a space having a given extent is formed in the puffer chamber, the puffer chamber-side exhaust hole and opening part communicate, and the closing member closes the operation rod-side exhaust hole.

It is preferable that the closing member is a pressure-activated valve, the pressure-activated valve opens the operation rod-side exhaust hole activated by pressure increase in an arcing space when arc is produced, and the pressure-activated valve keeps the operation rod-side exhaust hole closed even when the pressure in the arcing space increases again after the completion of the interruption movement. In the above description, the arcing space is a space enclosed with a stationary-side arcing contact 4, a movable-side arcing contact 5, and an insulating nozzle 12.

Further, it is preferable that the closing member is an exhaust closing cylinder inside which the puffer shaft slides, wherein the exhaust closing cylinder closes the operation rod-side exhaust hole at the place in the vicinity of the final end of the stroke of the interruption movement.

Furthermore, it is preferable that an evaporable member that evaporates by a high-temperature gas is provided on the interrupting section-side of the inside of the puffer shaft.

### Advantageous Effect of the Invention

According to the present invention, in the interruption process of the zero-missing current, an arc-extinguish gas can be blown continuously from the insulating nozzle for a longer time even after completion of the interruption movement by maintaining the gas pressure inside the puffer chamber using the residual arc in the interruption section. Thereby, it becomes practicable to interrupt not only a large current associated with an accident but also a zero-missing current, which is difficult to interrupt with an ordinary circuit breaker.

### BRIEF DESCRIPTION OF DRAWINGS

FIG. 1 is a sectional view that illustrates an overall configuration of the puffer type gas circuit breaker according to the first embodiment example of the present invention.

FIG. 2 is a sectional view that illustrates the circuit closed state of the puffer type gas circuit breaker according to the first embodiment example of the present invention.

FIG. 3 is a sectional view that illustrates the beginning state of the interruption movement (at the time when arc is produced) of the puffer type gas circuit breaker according to the first embodiment example of the present invention.

FIG. 4 is a sectional view that illustrates the state of completion of the interruption movement of the puffer type gas circuit breaker according to the first embodiment example of the present invention.

FIG. 5 is a detailed view that illustrates the flow control section 11 of the puffer type gas circuit breaker according to the present invention.

FIG. 6 is a characteristics comparison diagram that compares the puffing pressure curve P₁ in a conventional method and the puffing pressure curve P₂ in the puffer type gas circuit breaker according to the present invention.

FIG. 7 is a sectional view that illustrates the circuit closed state of the puffer type gas circuit breaker according to the second embodiment example of the present invention.

FIG. 8 is a sectional view that illustrates the beginning state of the interruption movement (at the time when arc is produced) of the puffer type gas circuit breaker according to the second embodiment example of the present invention.

FIG. 9 is a sectional view that illustrates the state of completion of the interruption movement of the puffer type gas circuit breaker according to the second embodiment example of the present invention.

FIG. 10 is a sectional view that illustrates the interruption section of the puffer type gas circuit breaker according to the third embodiment example of the present invention.

FIG. 11 is a characteristics diagram that shows the variation of puffing pressure in an example of conventional HSGS.

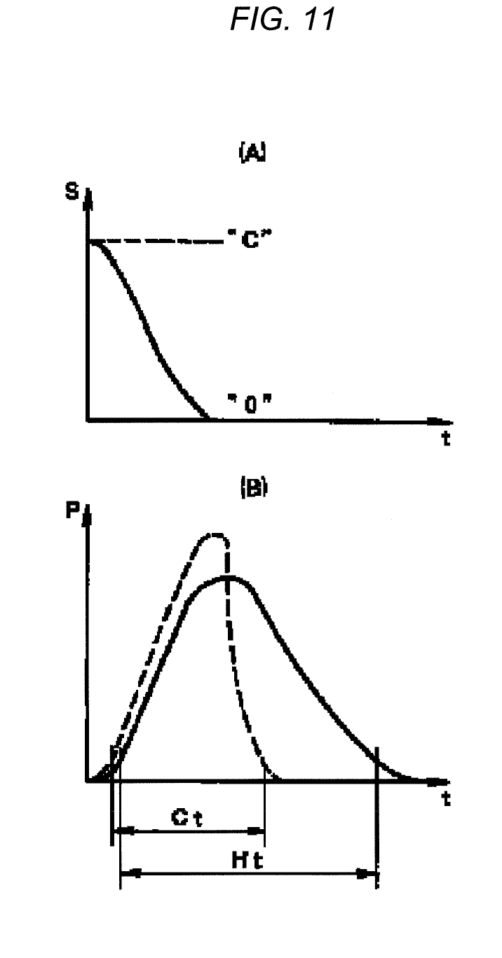

### DESCRIPTION OF EMBODIMENTS

### Embodiment Example 1

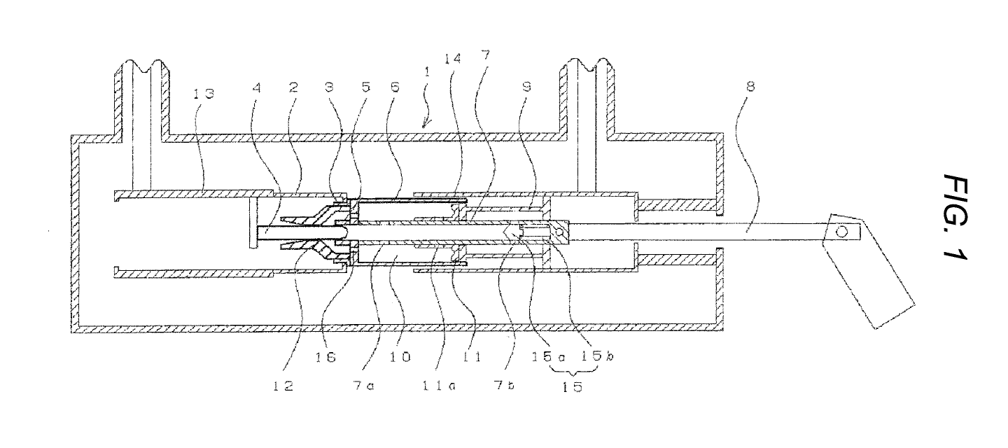

The following explains, referring to drawings, a puffer type gas circuit breaker by the present invention. FIG. 1 illustrates the circuit closed state of the interruption section of the puffer type gas circuit breaker according to an embodiment example of the present invention.

A stationary-side main contact 2 and a movable-side main contact 3, each of which is shaped annularly, are provided in a vessel 1 filled with an insulating gas such as SF₆ and are arranged on the same axis in such a manner that they position to face each other in opposite directions. Inside the stationary-side main contact 2, a stationary-side arcing contact 4 is concentrically provided. Inside the movable-side main contact 3, a movable-side arcing contact 5 is concentrically provided.

The stationary-side main contact 2 and the stationary-side arcing contact 4 are electrically connected to a stationary-side conductor 13. The movable-side main contact 3 and the movable-side arcing contact 5 are electrically connected to a movable-side conductor 14 through a puffer cylinder 6.

The movable-side arcing contact 5 is provided on the top end of the puffer cylinder 6. Inside the puffer cylinder 6, a puffer shaft 7 is concentrically provided and one end thereof is secured on the puffer cylinder 6. The other end of the puffer shaft 7 is connected to an insulative operation rod 8, thereby a driving force from an actuator (not illustrated) is transmitted to the movable side. The puffer shaft 7 is hollow; the hollow space has a role of working as an exhaust path of the hot gas caused by the arc produced in the interruption section.

The puffer shaft 7 has a puffer chamber-side exhaust hole 7a and an operation rod-side exhaust hole 7b for exhausting the hot gas caused by the arcing. On the actuator-side end of the hollow space of the puffer shaft 7, a pressure-activated valve 15, which is constituted with a valve 15a of conical shape and a return spring 15b, is provided.

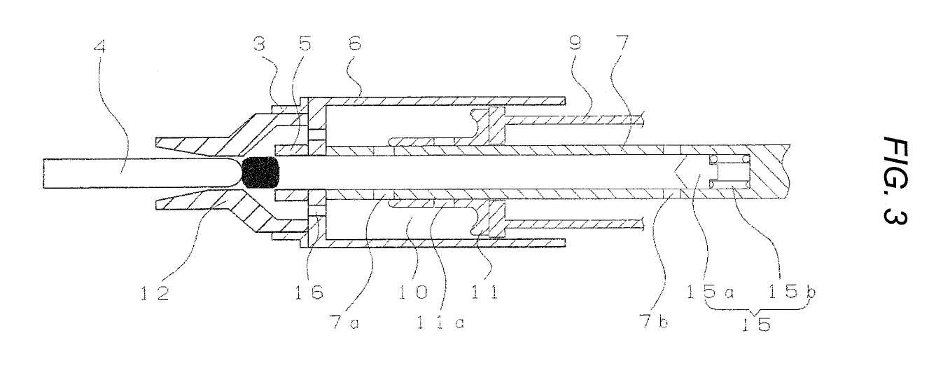

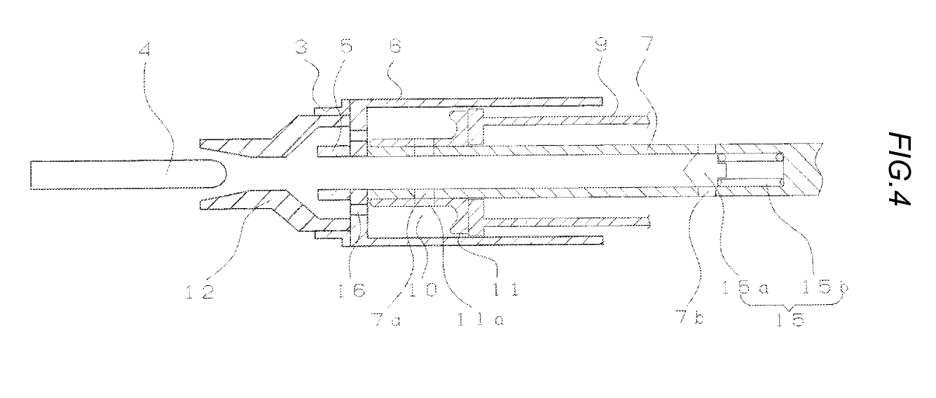

The pressure-activated valve 15 is pushed by the insulating gas of high-pressure, which is produced in the interruption section, to open the operation rod-side exhaust port 7b at the time of arcing as illustrated in FIG. 3, but works as a closing member for closing the operation rod-side exhaust hole 7b after completion of the interruption movement as illustrated in FIG. 4. It is a particularly preferable configuration that the operation rod-side exhaust hole 7b is kept closed after completion of the interruption movement even if the gas pressure is increased again by the zero-missing current. This configuration permits keeping the pressure inside a puffer chamber 10 higher than the gas pressure at the interruption section even after the completion of the interruption movement and consequently permits blowing insulating gas to the arc for a longer time.

In the state of completion of the interruption movement as illustrated in FIG. 4, the insulation gas of high-pressure, which is higher than that in a conventional art, caused by heat of the residual arc existing between the stationary-side arcing contact 4 and the movable-side arcing contact 5 flows into the puffer chamber 10 through the puffer shaft 7, the puffer chamber-side exhaust hole 7a communicating therewith, and an opening part 11a.

And then, the insulation gas is discharged from the puffer chamber 10 through an exhaust hole 16. The discharged gas flows out along an insulating nozzle 12 to blow the residual arc. This movement cycle continues while residual arc exists between the stationary-side main contact 2 and the movable-side main contact 3. Consequently, the insulation gas of high-pressure can blow for a longer time the area between the stationary-side arcing contact 4 and the movable-side arcing contact 5.

A puffer piston 6 slides on the inner surface of the space formed by the puffer shaft 7 and the puffer cylinder 6. This space formed by the puffer shaft 7, the puffer cylinder 6, and the puffer piston 9 is referred to as the puffer chamber 10. On the top end of the puffer piston 9, a flow control section 11 is provided. The capacity of the puffer chamber 10 at the time of completion of the interruption movement is suitably adjusted according to the nominal interruption current rating. The adjustment will generally be within the range of 30 to 50% compared to the capacity of the puffer chamber 10 at the time of the circuit closing.

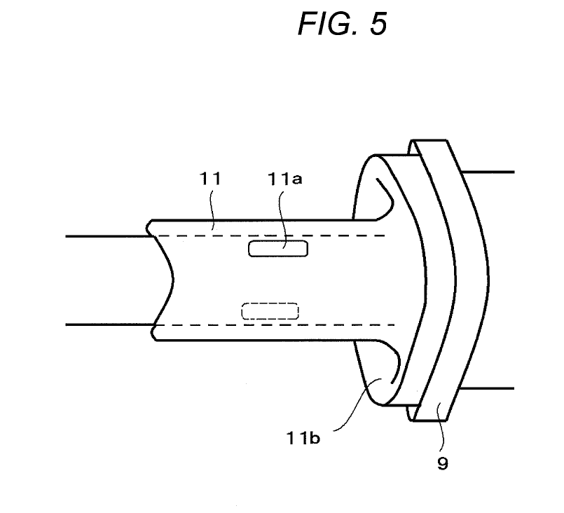

FIG. 5 illustrates details of the construction of the flow control section 11. The flow control section 11 has the opening part 11a and a flow guide 11b. As FIG. 4 illustrates, the opening part 11a communicates with the puffer chamber-side exhaust hole 7a at the time of completion of the interruption operation. The flow guide 11b is preferred to have a curved shape. Giving a curved shape to the flow guide 11 b allows the insulation gas of high-temperature and high-pressure flowed in the puffer chamber 10 to easily flow back to the interruption section through the exhaust hole 16.

The insulation nozzle 12 illustrated in FIGS. 1 to 4 is provided between the movable-side main contact 3 and the movable-side arcing contact 5 concentrically with them so that the insulation gas compressed in the puffer chamber 10 can be blown to the arc produced between the stationary-side arcing contact 4 and the movable-side arcing contact 5.

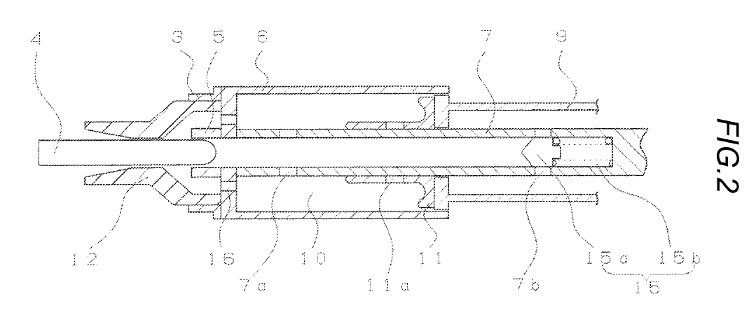

Next, the working of the puffer type circuit breaker by the present invention will be explained referring to FIGS. 2 to 4. FIG. 2 illustrates the state of circuit closed, that is, the interruption section is carrying current. In this state, the current path is formed in the route passing through, as FIG. 1 describes, the stationary-side conductor 13, the stationary-side main contact 2, the movable-side main contact 3, the puffer cylinder 6, and then the movable-side conductor 14.

The movement of the insulative operation rod 8 toward the right side of the illustration from the state illustrated in FIG. 2 causes the movable-side to move toward the right side of the illustration and their state consequently changes into the arcing state that FIG. 3 illustrates. Under this situation, arc is produced between the stationary-side arcing contact 4 and the movable-side arcing contact 5, and the interruption section becomes high-temperature condition as a consequence. Thereby the pressure-activated valve 15 is pushed toward the right side of the illustration and the operation rod-side exhaust hole 7b opens to blow out the insulation gas of high-pressure from the puffer shaft 7.

Thereafter, the movable-side further moves toward the right side of the illustration and the positional relationship between the stationary-side arcing contact 4 and the movable-side arcing contact 5 becomes a nearly intermediate state between the states illustrated in FIG. 3 and FIG. 4. At this time, the insulating gas of high-pressure is blown to the arc along the insulating nozzle 12 via the puffer chamber-side exhaust hole 7a, the puffer chamber 10, and the exhaust hole 16. The above is mechanism of a large current interruption.

In addition, the movable-side further moves toward the right side of the illustration, and the state changes into the condition where the interruption operation has completed that FIG. 4 illustrates. In this state, the pressure-activated valve 15 returns to close the operation rod-side exhaust hole 7b because the pressure at the interruption section lowers to a reduced level compared to the arcing state that FIG. 3 illustrates. In addition, the opening part 11a of the flow control section 11 and the puffer chamber-side exhaust hole 7a of the puffer shaft 7 communicate each other.

If residual arc exists in this state between the stationary-side arcing contact 4 and the movable-side arcing contact 5, the insulation gas of high-pressure heated by that arc flows through the puffer shaft 7 and goes into the puffer chamber 10 through the communicated puffer chamber-side exhaust hole 7a and the opening part 11a.

And then, the insulation gas flow out from the puffer chamber 10 through the blowing port 16. Then, the discharged gas flows out along the insulating nozzle 12 to blow the residual arc. This gas flow cycle continues while a residual arc exists between the stationary-side arcing contact 4 and the movable-side arcing contact 5. Consequently, the insulation gas of high-pressure can blow for a longer time the area between the stationary-side arcing contact 4 and the movable-side arcing contact 5.

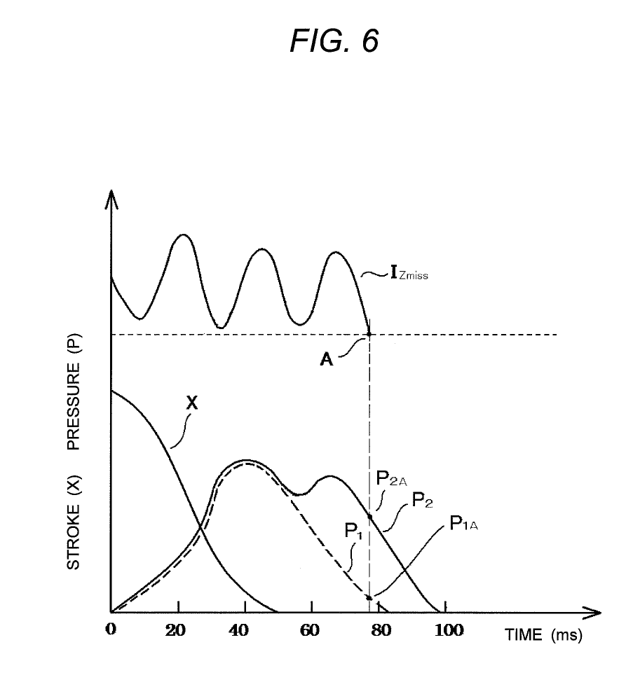

The following compares, referring to FIG. 6, the characteristics of the puffer pressure curve P₁ in a conventional method and the puffer pressure curve P₂ in the present embodiment example. The curve X represents the stroke of the interruption movement of a circuit breaker. The puffer pressure curve P₁ in the conventional method shows that the gas pressure gradually decreases in the latter half of the interruption movement. In contrast to this, the gas pressure in the present embodiment example increases again in the latter half of the interruption movement as the puffer pressure curve P₂ shows.

The next will explain, referring to FIG. 6 and contrasting to a conventional art, the mechanism of the interrupting of the zero-missing current I_{zmiss} in the puffer type circuit breaker by the present invention. In FIG. 6, the waveform after the occurrence of the zero-missing current crosses the zero line at first at the point A. At that time, the puffer chamber in the conventional method has a residual pressure at the level that the point P_{1A} on the puffer pressure curve P₁ indicates. In this case, there is a risk that the current cannot be interrupted because the pressure in the puffer chamber 10 is not sufficient.

On the other hand, when the puffer type circuit breaker having a puffer chamber by the present invention is used, the puffer chamber pressure corresponding to the point of the zero-current state is indicated with the point P_{2A}. As can be known from FIG. 6, the pressure at the point P_{2A} is much higher compared to the pressure at the point P_{1A}. Consequently, in the case where the puffer type circuit breaker having a puffer chamber by the present invention is used, it becomes possible to continue blowing insulating gas for a longer time at a pressure higher than the puffer pressure in an example of conventional art. Thereby, this enables the circuit breaker to interrupt not only a large current caused by an accident but also the zero-missing current of which interruption is difficult for an ordinary circuit breaker. Further, it becomes practicable to prevent reignition of the arc.

### Embodiment Example 2

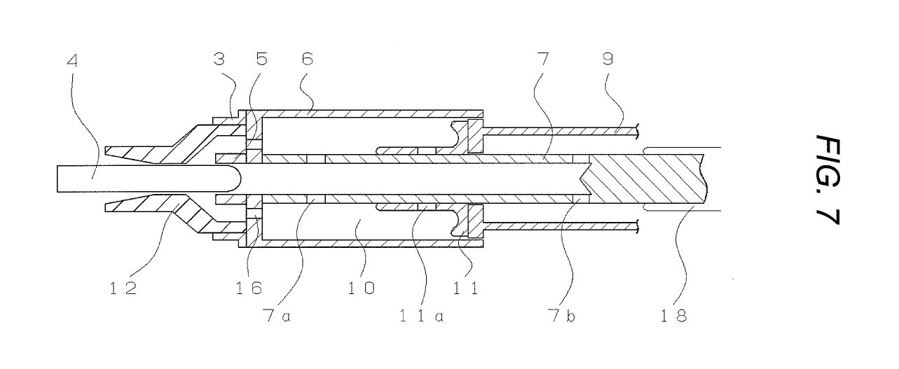

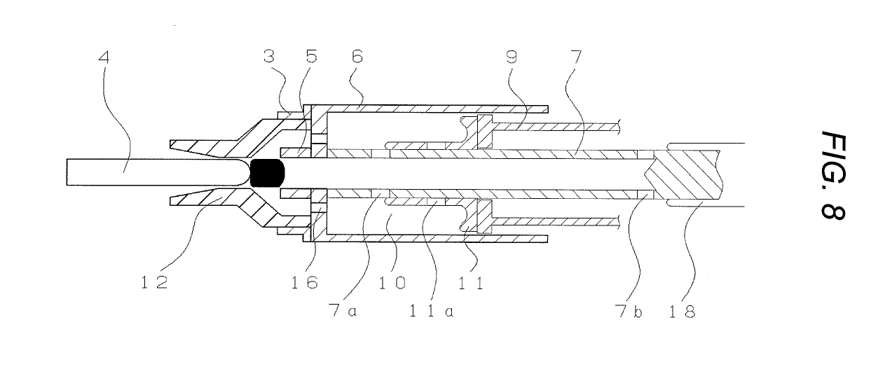

FIGS. 7 to 9 illustrate the second embodiment example of the present invention. The same constituents as those in the first embodiment example are denoted by the same reference numerals and detailed description thereof will be omitted. In the embodiment example 2, an exhaust closing cylinder 18 is used in place of the pressure-activated valve 15 of the embodiment example 1. The exhaust closing cylinder 18, which is an exhaust closing cylinder and a puffer shaft 7 slides on the inner periphery thereof, closes an operation rod-side exhaust hole 7b at the place in the vicinity of the final end of the stroke of the interruption movement.

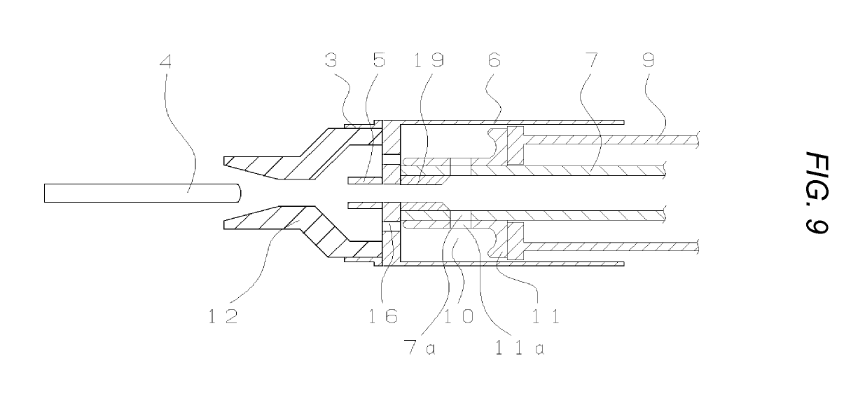

In the same manner as in the embodiment example 1, the exhaust closing cylinder 18 has a role of working as a sealing member for closing the operation rod-side exhaust hole 7b after completion of the interruption operation illustrated in FIG. 9. It is more preferable that the operation rod-side exhaust hole 7b should be closed at the timing when the pressure of the interruption section begins to again rise after completion of the interruption operation.

By doing so, it becomes possible to maintain the pressure in a puffer chamber 10 higher than the gas pressure at the interruption section after the completion of the interruption movement, enabling the blowing of the insulating gas to the residual arc in the interruption section for a longer time. In addition to the effect shown in the embodiment example 1, the construction of the present embodiment example is simple and consequently leads to increase in reliability and reduction in manufacturing cost.

### Embodiment Example 3

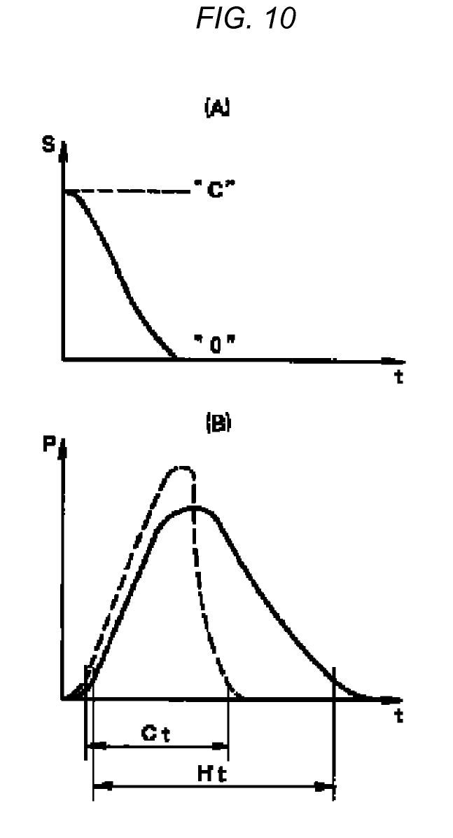

FIG. 10 illustrates a third embodiment example of the present invention. The same constituents as those in the first and the second embodiment examples are denoted by the same reference numerals and detailed description thereof will be omitted. In the embodiment example 3, an evaporable member 19 such as polytetrafluoroethylene (PTFE), which evaporates by a high temperature gas, is arranged on the interruption section-side in a puffer shaft 7.

In the interruption movement, a hot gas generated by the arc flows into the puffer shaft 7 to raise the temperature of the evaporable member 19 causing generation of evaporation gas. By feeding the evaporation gas to a puffer chamber 10 through a puffer chamber-side exhaust hole 7a and an opening part 11 a, temperature of the gas inside the puffer chamber 10 can be further raised to increase the gas pressure more. Thus, it becomes possible in addition to the effects shown in the first and second embodiment examples to interrupt more efficiently a large current and the zero-missing current. Further, it becomes possible to prevent more reliably reignition of the arc that may occur after interruption of a large current.

1. A puffer type gas circuit breaker comprising:
a vessel being filled with insulating gas;
a stationary-side main contact and a movable-side main contact that being provided in the vessel and on the same axis so that they position to face each other in opposite directions;
a stationary-side arcing contact and a movable-side arcing contact that being concentrically provided inside the stationary-side main contact and the movable-side main contact respectively;
a puffer cylinder, the movable-side arcing contact being provided on the top end of the puffer cylinder;
a puffer shaft having a puffer chamber-side exhaust hole and an operation rod-side exhaust hole, the puffer shaft being concentrically provided inside the puffer cylinder;
a closing member closing the operation rod-side exhaust hole;
a puffer piston sliding on the inner surface of a space formed by the puffer cylinder and the puffer shaft;
a flow control section having an opening part, the opening part is communicable with the puffer chamber-side exhaust hole, the flow control section being provided on the puffer piston and in a puffer chamber formed by the puffer cylinder and the puffer shaft and the puffer piston; and
an insulating nozzle being provided concentrically with the movable-side arcing contact, the insulating nozzle blows an insulating gas compressed within the puffer chamber to the arc produced between the stationary-side arcing contact and the movable-side arcing contact;
wherein, when an interruption operation is completed,
a space having a given extent is formed in the puffer chamber; the puffer chamber-side exhaust hole communicate with the opening part; and the closing member closes the operation rod-side exhaust hole.

2. A puffer type gas circuit breaker according to claim 1, wherein the closing member is a pressure-activated valve; the pressure-activated valve opens the operation rod-side exhaust hole activated by pressure increase in an arcing space when arc is produced; and the pressure-activated valve keeps the operation rod-side exhaust hole closed even when the pressure in the arcing space increases again after the completion of the interruption movement.

3. A puffer type gas circuit breaker according to claim 1, wherein the closing member is an exhaust closing cylinder inside which the puffer shaft slides; and the exhaust closing cylinder closes the operation rod-side exhaust hole at the place in the vicinity of the final end of the stroke of the interruption movement.

4. A puffer type gas circuit breaker according to claim 1, wherein an evaporable member that evaporates by a high-temperature gas is provided on the interrupting section-side of the inside of the puffer shaft.
